(19) United States
(12) Patent Application Publication
(10) Pub. No.: US 2026/0177845 A1
(43) Pub. Date: Jun. 25, 2026

(54) EYEWEAR SYSTEM WITH INTERCHANGEABLE CLIP-ON FRAME AND STABILIZING NOSE BRIDGE HOOK

(71) Applicants: Yahong Sun, Brooklyn, NY (US); Changhong Ren, Brooklyn, NY (US); Lerong Sun, Brooklyn, NY (US)

(72) Inventors: Yahong Sun, Brooklyn, NY (US); Changhong Ren, Brooklyn, NY (US); Lerong Sun, Brooklyn, NY (US)

(21) Appl. No.: 19/222,458

(22) Filed: May 29, 2025

Related U.S. Application Data
(60) Provisional application No. 63/738,139, filed on Dec. 23, 2024.

(51) Int. Cl. G02C 13/00; G02C 5/02

(52) U.S. Cl. CPC G02C 13/001; G02C 5/02; G02C 2200/02; G02C 2200/08

(57) ABSTRACT

An eyewear system is provided that includes a base frame and an interchangeable clip-on frame for customizable styling. The system features a stabilizing hook located on the nose bridge of the base frame, which engages a corresponding structure on the clip-on frame to provide a secure central attachment. Magnets are embedded at opposing ends of both the clip-on frame and the base frame to facilitate magnetic coupling, ensuring precise alignment and additional stability. This dual securing mechanism prevents displacement or gaps even when the base frame bends inward or outward, such as from the weight of prescription lenses. The system allows users to easily swap clip-on frames with different patterns or colors, offering both functional reliability and aesthetic flexibility.

### CROSS-REFERENCE TO RELATED APPLICATION

This application claims the benefit of priority of U.S. provisional application number 63/738,139, filed Dec. 23, 2024, the contents of which are herein incorporated by reference.

### BACKGROUND OF THE INVENTION

Eyewear has evolved significantly over the past century, transitioning from simple vision correction tools to complex fashion accessories and technological devices. In recent years, consumers have increasingly sought eyewear that serves not only a functional purpose but also allows for personalization and adaptability. In response, manufacturers have introduced a variety of interchangeable elements, such as clip-on attachments or decorative overlays, aimed at providing users with the flexibility to modify the look of their eyewear to suit different styles or occasions. These innovations represent an attempt to meet the demands of a more style-conscious and expressive user base.

However, many of the current interchangeable eyewear solutions suffer from notable shortcomings. Chief among these is the issue of stability—particularly in the area around the nose bridge, where structural integrity is most critical for maintaining a secure fit. Traditional clip-on mechanisms often rely solely on side-mounted magnets or simple mechanical snaps, which can fail to provide the necessary holding power, especially when the underlying frame experiences any flex or distortion. This lack of robustness can result in the attachments becoming misaligned or dislodged, thereby diminishing both the aesthetic value and functional reliability of the eyewear.

Moreover, users with prescription lenses frequently encounter additional challenges. Thicker lenses can introduce an imbalance or cause bending of the base frame, particularly near the nose bridge. This deformation can disrupt the intended fit of any interchangeable face frames or accessories, often creating visible gaps or causing components to detach entirely. The problem is exacerbated in eyewear designs that rely exclusively on magnetic force or do not account for variations in frame tension. As such, these systems fall short in delivering a consistent and seamless interchangeable experience for all users, especially those requiring higher prescription strengths.

The consumer desire for stylish, adaptable eyewear continues to grow, yet current market offerings fail to provide a robust, stable, and user-friendly means of personalization. Particularly absent are solutions that address the mechanical challenges posed by frame deformation and ensure secure attachment of interchangeable components under varied use conditions. Therefore, the need exists for eyewear that offers a reliable, structurally sound method of integrating interchangeable frames, thereby allowing users to confidently modify their eyewear's appearance without compromising fit, stability, or function.

### SUMMARY OF THE INVENTION

The present invention provides an eyewear system with a dual securing mechanism comprising a mechanical hook and magnetic coupling to ensure stable attachment of interchangeable clip-on frames. Traditional clip-on systems often suffer from instability, particularly around the nose bridge, and are prone to detachment or misalignment if the base frame flexes or bends. These deficiencies can result in gaps between the clip-on frame and the base frame or the clip-on falling off entirely.

The invention addresses these and other problems with conventional products by incorporating a secure mechanical hook at the nose bridge of the clip-on frame, which engages with the nose bridge of the base frame to provide a central locking mechanism. Additionally, magnets are embedded at opposing ends of both the clip-on frame and the base frame to facilitate magnetic coupling, ensuring precise alignment and enhanced retention. This combination of mechanical and magnetic attachment ensures a stable, flush, and gap-free engagement even when the base frame bends inward or outward due to lens weight or external pressure.

The design allows for quick and easy interchange of decorative or prescription clip-on frames, giving users the flexibility to modify their eyewear's appearance to suit different styles or occasions. The system is compatible with various lens thicknesses and prescription strengths, addressing the mechanical challenges posed by frame deformation and ensuring secure attachment under varied use conditions.

Accordingly, the invention provides a durable, user-friendly solution for customizable eyewear that overcomes the limitations of conventional clip-on systems and enhances both function and fashion. These and other features, aspects, and advantages of the present invention will become better understood with reference to the following drawings, description, and claims.

### BRIEF DESCRIPTION OF THE DRAWINGS

FIG. 1 is a front perspective view of an attached interchangeable clip-on frame in accordance with an embodiment of the present invention;

FIG. 2 is a front perspective view of a base frame in accordance with an embodiment of the present invention;

FIG. 3 is a front perspective view illustrating the clip-on frame secured to the base frame, with the nose bridge hook engaged and the magnets aligned to maintain attachment;

FIG. 4 is a top view illustrating the clip-on frame secured to the base frame, with the nose bridge hook engaged and the magnets aligned to maintain attachment;

FIG. 5 is an exploded top view illustrating how the clip-on frame is secured to the base frame, with the nose bridge hook engaged and the magnets aligned to maintain attachment;

FIG. 6 is a top view illustrating an alternative embodiment comprising a clip-on frame with a curved nose bridge portion secured to a base frame, with the nose bridge hook engaged and the magnets aligned to maintain attachment;

FIG. 7 is an exploded top view illustrating how the alternative embodiment clip-on frame is secured to the base frame, with the nose bridge hook engaged and the magnets aligned to maintain attachment; and

FIG. 8 is an exploded view the nose bridge hook of the clip-on frame.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

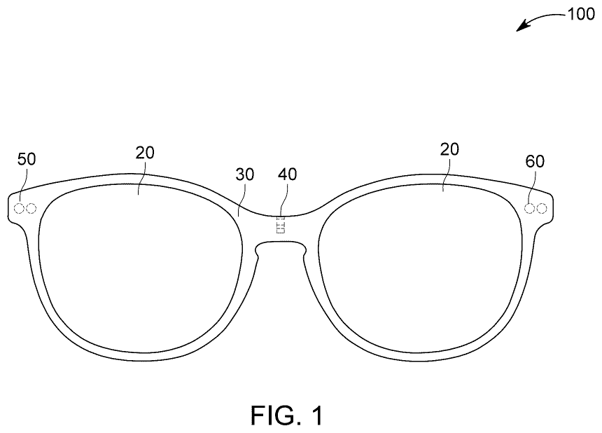

Referring now to FIGS. 1-8, the present invention is directed to eyewear featuring interchangeable clip-on frames for enhanced personalization and structural stability.

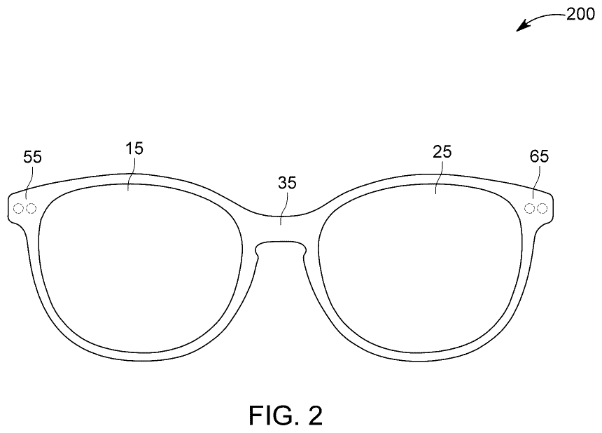

FIG. 1 illustrates a perspective view of the clip on frame (100) in accordance with a preferred embodiment of the present invention, and FIG. 2 illustrates a perspective view of a base frame (200) in accordance with a preferred embodiment of the present invention.

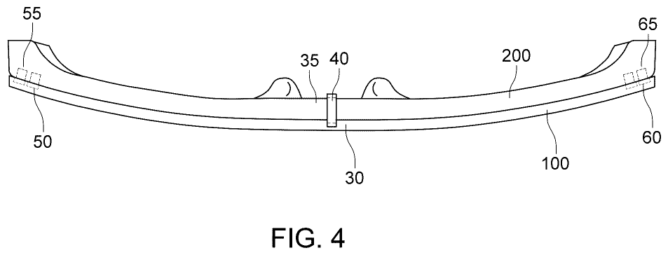

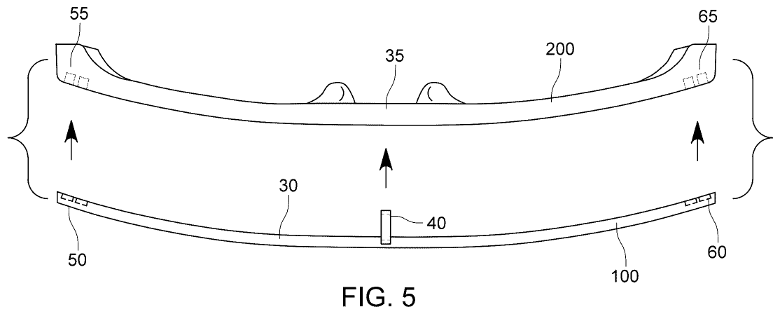

As seen by way of example in FIG. 1, clip on frame (100) comprises a left lens (10) and a right lens (20), and nose bridge (30) having nose bridge hook (40) thereon. Clip on frame (100) further comprises magnets (50, 60) integrated at opposing ends of the clip-on frame (100), which are aligned to mate with corresponding magnets (55, 65) embedded in the ends of the base frame (200) as seen in FIGS. 4 and 5. Clip-on frame (100) is configured to selectively attach to the base frame (200), thereby allowing a user to alter the aesthetic appearance of the eyewear without replacing the underlying prescription or base frame.

As shown in FIG. 2, the base frame (200) includes a centrally located nose bridge (35), which is designed to securely engage nose bridge hook (40) positioned on the clip on frame nose bridge (30). This hook-and-bridge interface creates a firm central anchor point that significantly improves the mechanical stability of the clip-on frame when mounted. By engaging the hook (40) with the nose bridge (35), the assembly resists displacement even if the clip on frame (100) or base frame (200) flexes inward or outward due to lens thickness, user handling, or external pressure.

Further stabilizing the attachment, base frame (200) includes one or more magnets disposed at its lateral ends. Specifically, FIGS. 2-5 shows magnets (55, 65) integrated at opposing ends of the base frame (200). These magnets are aligned to mate with corresponding magnets (50, 60) embedded in the ends of the clip on frame (100). When the clip-on frame is brought near the base frame, the magnets (50, 60) automatically align with the base frame magnets (55, 65), drawing the components together and help secure the clip in frame place. This magnetic coupling works in conjunction with the nose bridge hook (40) to ensure a secure, flush fit that eliminates gaps—even when the base frame experiences structural bending.

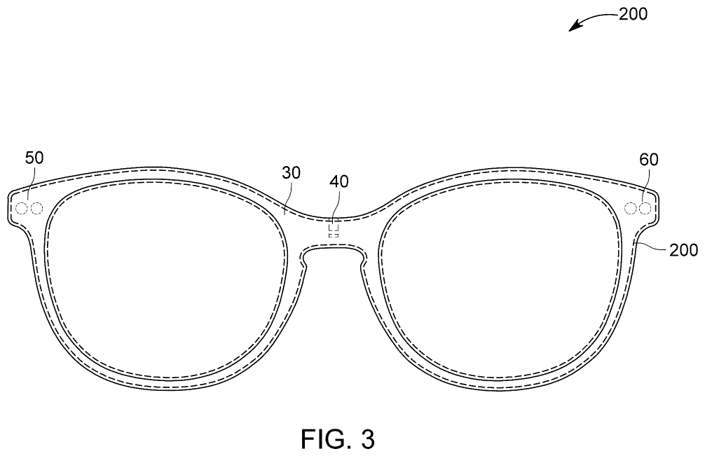

The installation process is both intuitive and efficient. As depicted in FIGS. 3-5, the user begins by positioning the clip-on frame (100) so that the clip-on nose bridge (30) and hook (40) align with the base frame nose bridge (35). With a slight downward and inward pressure, the user snaps the clip on frame (100) into place, ensuring the hook (40) is fully engaged with the base frame nose bridge (35). Once centered, the magnets (50, 60) at each end of the clip-on frame (100) are automatically pulled into position by the magnets (55, 65) in the base frame (200), thereby completing the secure attachment. To remove the clip-on frame, the user reverses the process—applying gentle outward pressure at the nose bridge to release the hook, followed by lifting the clip-on frame away from the base frame.

As illustrated in FIG. 5, by way of example the design accommodates various interchangeable clip-on frames with differing decorative patterns or colors, enabling users to tailor their eyewear to their style or mood. The combination of the central nose bridge hook (40) and opposing magnet pairs (50, 60/55, 65) ensures that the clip-on frame (100) maintains a flush, gap-free engagement with the base frame (200), even when subjected to structural stress. This robust configuration resolves common shortcomings found in prior interchangeable eyewear systems, where reliance solely on magnetic or friction-based retention resulted in loose fittings, misalignments, or instability during use.

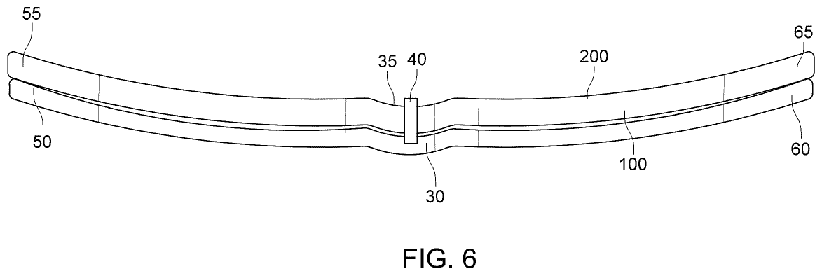

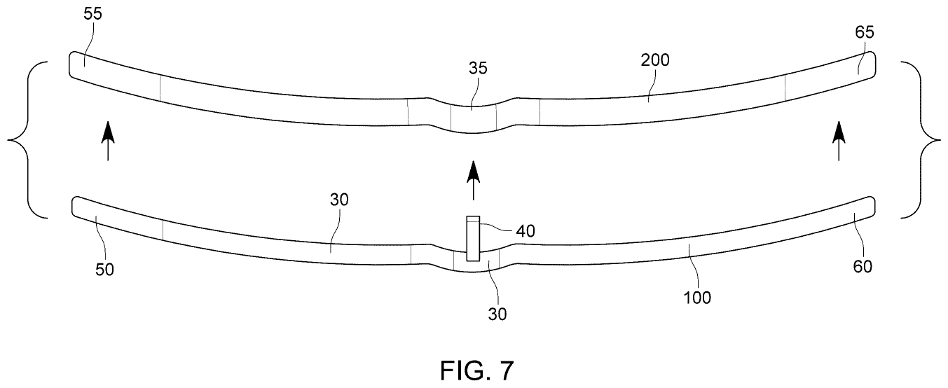

FIGS. 6 and 7 depict an alternative design comprising a curved nose bridge. As with the earlier embodiment, the clip-on frame 100 serves as an integral part of the eyewear system, designed to provide users with the ability to personalize the appearance of their glasses. The clip-on frame 100 is configured to be removably attached to the base frame 200, enabling quick and seamless interchangeability. The clip-on frame 100 includes a left lens and a right lens, which are connected by the curved nose bridge 30. The clip-on frame 100 is constructed from lightweight yet durable materials to ensure comfort during wear while maintaining structural integrity. The clip-on frame 100 incorporates magnets 50 and 60 at opposing ends, which align with corresponding magnets 55 and 65 on the base frame 200 to enable magnetic coupling. This magnetic interaction ensures precise alignment and stability of the clip-on frame 100 when attached to the base frame 200.

The base frame 200 also serves as a foundational structure of the eyewear system, providing support for the clip-on frame 100 and housing the base lenses. The base frame 200 includes a left base lens and a right base lens, which are connected by a curved base nose bridge 35. The base frame 200 is designed to accommodate the clip-on frame 100 through a combination of mechanical and magnetic engagement mechanisms. Magnets 55 and 65 are embedded at the opposing ends of the base frame 200, corresponding to the magnets 50 and 60 on the clip-on frame 100. These magnets ensure a secure and flush attachment of the clip-on frame 100 to the base frame 200, even under conditions of structural stress or deformation. The base frame 200 is constructed to withstand the weight of prescription lenses and external forces while maintaining compatibility with the clip-on frame 100.

The curved nose bridge 30 serves as a central structural component of the clip-on frame 100, connecting the left and right clip-on lenses. The curved nose bridge 30 is designed to align with the curved base nose bridge 35 of the base frame 200, enabling the mechanical engagement of the two frames. The curved nose bridge 30 incorporates a nose bridge hook 40, which plays an important role in securing the clip-on frame 100 to the base frame 200. The curved nose bridge 30 is constructed to provide both flexibility and durability, promoting a comfortable fit for the user while maintaining the stability of the clip-on frame 100.

As shown in FIGS. 6 and 7, the curved nose bridge 35 is a structural feature of the base frame 200, designed to engage with the curved nose bridge hook 40 of the clip-on frame 100. The curved nose bridge 35 provides a central anchoring point for the clip-on frame 100, ensuring a secure attachment that resists displacement. The curvature of the nose bridge 35 is specifically designed to complement the shape of the curved nose bridge hook 40, creating a mechanical lock that enhances the stability of the eyewear system. The curved nose bridge 35 is constructed from materials that provide both strength and flexibility, allowing the nose bridge to accommodate variations in frame tension and user handling.

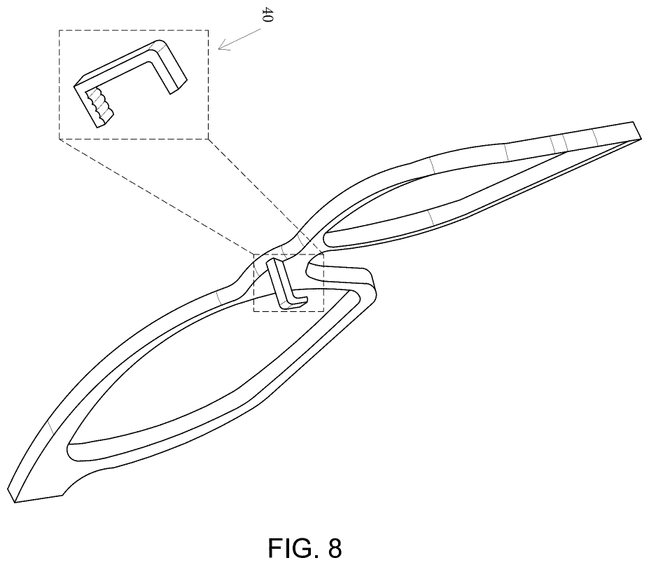

FIG. 8 illustrates an exploded view of the nose bridge hook (40) in accordance with a preferred embodiment of the present invention.

The curved nose bridge hook 40 is a component of the clip-on frame 100, designed to engage with the curved nose bridge 35 of the base frame 200. The curved nose bridge hook 40 provides a mechanical locking mechanism that secures the clip-on frame 100 to the base frame 200 at the central region of the eyewear system. The hook 40 is shaped to complement the curvature of the base nose bridge 35, ensuring a tight and stable fit. The curved nose bridge hook 40 is constructed from materials that provide both rigidity and resilience, allowing the hook to maintain its shape and function under repeated use.

The magnets 50 and 60 are embedded at the opposing ends of the clip-on frame 100, serving as part of the magnetic coupling mechanism that secures the clip-on frame 100 to the base frame 200. The magnets 50 and 60 are strategically positioned to align with the corresponding magnets 55 and 65 on the base frame 200. This alignment ensures a strong magnetic attraction that enhances the stability and alignment of the clip-on frame 100 when attached to the base frame 200. The magnets 50 and 60 are embedded within the material of the clip-on frame 100 to ensure durability and to maintain the aesthetic appearance of the eyewear system.

The magnets 55 and 65 are embedded at the opposing ends of the base frame 200, corresponding to the magnets 50 and 60 on the clip-on frame 100. These magnets play a significant role in the magnetic coupling mechanism, providing additional stability and alignment for the clip-on frame 100. The magnets 55 and 65 are positioned to ensure a flush and gap-free attachment of the clip-on frame 100 to the base frame 200, even under conditions of structural stress or deformation. The magnets 55 and 65 are embedded within the material of the base frame 200 to protect them from wear and to maintain the overall aesthetic of the eyewear system.

This system provides users with a reliable, aesthetically versatile, and structurally secure solution for interchangeable eyewear, enhancing both functionality and user satisfaction.

It should be understood, of course, that the foregoing relates to exemplary embodiments of the invention and that modifications may be made without departing from the spirit and scope of the invention as set forth in the following claims.

What is claimed is:

1. An eyewear system comprising:
a base frame comprising a left base lens, a right base lens, and a base nose bridge extending between the left and right base lenses;
a clip-on frame comprising a left clip-on lens, a right clip-on lens, and a clip-on frame nose bridge extending between the left and right clip-on lenses;
a hook disposed on the clip on nose bridge;
the base frame nose bridge configured to engage with the hook on the clip on nose bridge to secure the clip-on frame to the base frame at a central region of the eyewear system;
a first set of magnets disposed at opposing ends of the clip-on frame;
a second set of magnets disposed at corresponding opposing ends of the base frame;
wherein the first set of magnets and the second set of magnets are aligned such that magnetic attraction assists in securing the clip-on frame to the base frame;
whereby the engagement of the hook and the magnetic coupling provides a stable attachment that resists displacement even when the base frame flexes.

2. The eyewear system of claim 1, wherein the hook is integrally formed with or fixed to the clip on nose bridge.

3. The eyewear system of claim 1, wherein the magnets are embedded within the material of the clip-on frame and base frame.

4. The eyewear system of claim 1, wherein the hook provides a vertical locking engagement with the base frame nose bridge.

5. The eyewear system of claim 1, wherein the hook and the magnets are arranged such that no visible gap is created between the clip-on frame and the base frame when the base frame bends inward or outward.

6. An eyewear system comprising:
a base frame including a nose bridge and a pair of opposing ends;
a clip-on frame configured to be removably attached to the base frame, the clip-on frame including a central bridge region and two ends;
a mechanical engagement element comprising a hook disposed on the nose bridge of the clip on frame and designed and positioned to releasably engage with the bridge region of the base frame;
at least one magnetic pair comprising a magnet on each end of the clip-on frame and a corresponding magnet on each end of the base frame;
wherein the mechanical engagement element and the magnetic pair cooperate to removably secure the clip-on frame to the base frame with enhanced stability and resistance to misalignment.

7. An eyewear assembly comprising:
a base frame comprising:
a left base lens and a right base lens; and
a curved base nose bridge extending between the left base lens and the right base lens, the curved base nose bridge having a contoured profile defining a central engagement surface;
a clip-on frame removably attachable to the base frame, the clip-on frame comprising:
a left clip-on lens and a right clip-on lens; and
a curved clip-on nose bridge extending between the left clip-on lens and the right clip-on lens, the curved clip-on nose bridge incorporating a nose bridge hook configured to engage with the curved base nose bridge;
a first set of magnetic elements embedded near opposing lateral ends of the clip-on frame;
a second set of magnetic elements embedded near corresponding opposing lateral ends of the base frame; and
wherein, upon attachment of the clip-on frame to the base frame, the nose bridge hook engages the contoured surface of the curved base nose bridge to provide a central mechanical locking engagement, and the first and second sets of magnetic elements align to generate magnetic attraction that stabilizes the clip-on frame in a flush, gap-free relation with the base frame.

8. The eyewear system of claim 7, wherein the hook is formed as part of or attached to the clip-on nose bridge.

9. The eyewear system of claim 7, wherein the hook provides a vertical locking engagement with the base frame curved nose bridge.

10. The eyewear system of claim 7, wherein the hook and the magnets are arranged such that a gap is created between the clip-on frame and the base frame.
